(19) United States
(12) Patent Application Publication
(10) Pub. No.: US 2013/0028682 A1
(43) Pub. Date: Jan. 31, 2013

(54) Zero-Added Footprint Captive Float Nut

(71) Applicant: Itzhak Sapir, Irvine, CA (US)

(72) Inventor: Itzhak Sapir, Irvine, CA (US)

(21) Appl. No.: 13/526,221

(22) Filed: Jun. 18, 2012

Related U.S. Application Data
(60) Provisional application No. 61/511,808, filed on Jul. 26, 2011.

(51) Int. Cl. F16B 39/10

(52) U.S. Cl. 411/116

(57) ABSTRACT

A captive float nut comprising a nut body having a threaded aperture defined there-through for receiving a threaded shaft. An anchor element is moveably coupled to the nut body to provide a predetermined freedom of movement of the nut body in six degrees of freedom. The anchor element comprises one or more finger elements having outwardly depending terminal portions have a sharp tine element on the terminal portion. The tines are driven in the interior surface of a bore so as to grip and affix the anchor element therein and affix the captive float nut to a structure.

### CROSS-REFERENCE TO RELATED APPLICATIONS

This application claims the benefit of U.S. Provisional Patent Application No. 61/511,808, filed on Jul. 26, 2011 and entitled “Captive Float Nut” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of fastening devices. More specifically, the invention relates to a zero-added footprint captive float nut for use on a structure such as an aircraft or unmanned aerial vehicle (“UAV”) frame.

2. Description of the Related Art

Captive float nuts are used in aircraft and other mechanical assembly processes in the form of a nut that is loosely fitted into and mechanically coupled to an anchor so that when the end fastener such as a bolt is installed, the nut is positioned to accept it while correcting for any lateral misalignment. The anchor is configured to take the installation loads including fastener insertion loads and tightening torque loads.

Prior art captive float nuts require special preparation of the structure including defining holes for rivets or screws or surface preparation and curing down-time for adhesives. In addition, lower surface area around the hole or bore for receiving the nut must be reserved for the anchor, adding to design constraints.

Prior art captive float nuts generally comprise a stationary portion or anchor; typically in the form of a plate or a bracket that is affixed to the structure underlying structure using for instance, rivets, adhesive or screws. The anchor portion in prior art captive float nuts consumes additional area around the lower surface perimeter of the nut, i.e., a portion of the underlying structure upon which the fastening assembly is used.

No known solution exists that provides a zero-added footprint to the size of the bare captive nut member. In addition, no solution exists with a relatively simple installation process for a captive float nut.

The current use of bonded captive float nut plates in military aircraft presents several problems including cumbersome logistics (e.g., special packaging and date tracking), complicated and procedure-sensitive installation processes and potential complications due to adhesive overflow and risk of Foreign Object Debris (FOD).

In light of these deficiencies in the prior art, a zero-added-footprint captive float nut is disclosed herein.

### BRIEF SUMMARY OF THE INVENTION

In one aspect of the invention, a zero-added footprint captive float nut is provided comprised of a nut body having an aperture defined there-through and comprising a base element, a shaft element, and a flange element. The interior walls of the aperture may be threaded for the receiving of a threaded member such as a threaded bolt shaft.

The invention further comprises an anchor element comprising a retaining element and at least one finger element having a tine element defined on an outwardly depending terminal portion of the finger element. The anchor element is coupled to and moveably affixed to the nut body to permit a predetermined range of motion of the anchor element in six degrees of freedom with respect to the nut body.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a first perspective view of the captive float nut of the invention.

FIG. 2 depicts a second perspective view of the captive float nut of the invention.

FIG. 3 depicts the captive float nut of the invention aligned for installation in a bore defined in a material with the installation tool of the invention aligned for locking the captive float nut within the bore.

FIG. 4 depicts a cross-section of the captive float nut of the invention disposed within a bore defined in a material prior to being locked into place by the installation tool.

FIG. 5 depicts a cross-section of the captive float nut of the invention disposed within a bore defined in a material during locking into place by the installation tool.

FIG. 6 depicts a cross-section of the captive float nut of the invention disposed within a bore defined in a material subsequent to being locked into place by the installation tool.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

As will be apparent in the following detailed description, key benefits of the zero-added footprint captive float nut of the invention herein include the elimination of the requirement for hole or surface preparation, quick and easy installation, no downtime after installation, no special logistic requirements for delivery and storage of nuts, minimal added weight, the ability to provide different nut configurations such as a self-locking nut or special materials in the configuration of the captive float nut of the invention and reduced foreign object debris or “FOD” risk.

The captive float nut of the invention is a different type of captive float nut from those in the prior art. It does not have or require a plate-like anchor and does not use an adhesive of any kind. The area it consumes on the structure's surface is effectively the area of the bare nut—thus the zero-added-footprint captive float nut. No preparation for the captive float nut installation is required because it is designed to fit into standard hole sizes for different standard fastener sizes. The installation process is simple with an easy-to-use installation tool and is completed in a short time. Beneficially, there is no down time after the installation as required when using an adhesive.

Turning now to the figures wherein like references define like elements among the several views, Applicant discloses a zero-footprint captive float nut.

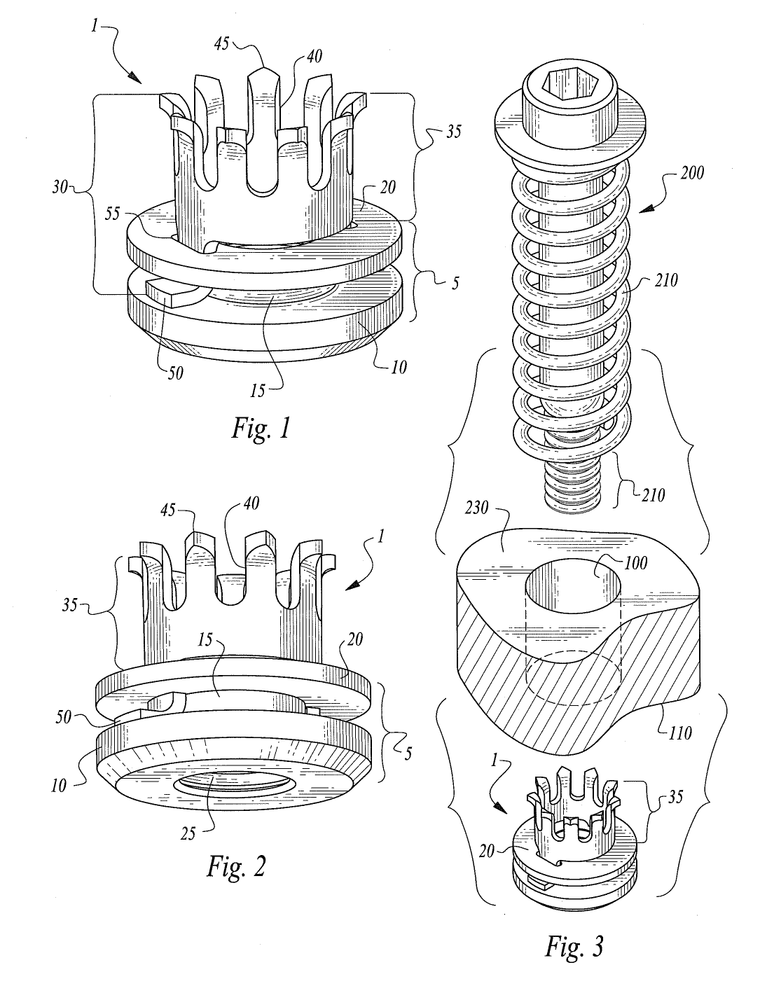

With respect to FIGS. 1 and 2, the captive float nut 1 of the invention is comprised of a nut body 5 comprising a base element 10, a shaft element 15, a flange element 20 and having an aperture 25 defined there-through.

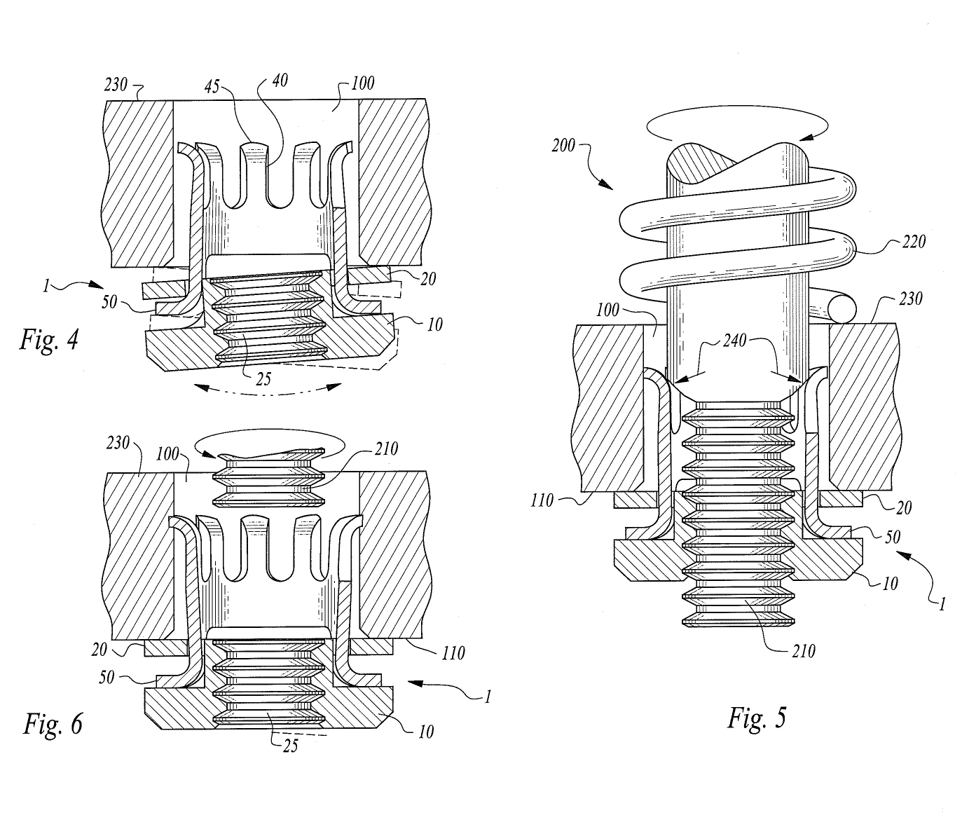

As more clearly illustrated in FIGS. 4-6, the interior walls of aperture 25 are preferably internally threaded for the receiving of a threaded member such as a threaded bolt shaft.

The invention further comprises an anchor element 30 comprising a retaining element 35 and at least one finger element 40 having a tine element 45 defined on an outwardly depending terminal portion of finger element 40 for gripping the interior of a bore in a material such as an aircraft structural element comprised of an aluminum or composite material. In a preferred embodiment, anchor element 30 is fabricated from a spring steel material.

As best illustrated in FIG. 4, anchor element 30 is moveably coupled to and affixed to nut body 5 to permit a predetermined range of motion of anchor element 30 in six degrees of freedom with respect to nut body 5. In other words, the two elements are mechanically connected to each other like links in a metal chain but are loosely mechanically coupled to permit a small amount of rotational and translational movement between them.

In this manner, when captive float nut 1 is locked into bore 100, installation and machining tolerance errors are accommodated to the extent and limit of the range of motion of nut body 5 as permitted by the respective dimensions of locking element 50 and locking aperture 55 of FIG. 1.

Turning to FIGS. 3-6, a preferred installation method, tool and device are depicted.

As seen in FIGS. 3 and 4, at installation, anchor element 30 is aligned and inserted into a bore 100 in a material such that the surface of flange element 20 abuts the lower material surface 110 captive float nut 1.

Installation tool 200 comprises a fluted shaft element comprising a threaded portion 210 and a tensioning element 220 such as a helical metal spring or equivalent tensioning element used to upwardly urge and stabilize captive float nut 1 within bore 100 during installation as best illustrated in FIG. 5.

Threaded portion 210 is next thread-ably inserted into aperture 25 and received by the threads defined on the interior surface thereof. As the shaft of installation tool 200 is drawn into the threads of aperture 25, tensioning element 220 is configured so as to abut the upper material surface 230. As installation tool 200 is drawn in further during installation, the upward tension on captive float nut 1 increases, further stabilizing captive float nut 1 within bore 100.

The shaft element of installation tool 200 is provided with a tapered portion 240. The dimensions and geometry of anchor element 30 and finger elements 40 are configured to cooperate with installation tool 200 such that, at a predetermined depth of penetration within aperture 25, tapered portions 240 downwardly contact finger elements 40 and forcibly urge them outwardly as tapered portion 240 is driven further into aperture 25. This, in turn, drives tine elements 45 into the interior surface material of bore 100, thereby gripping the interior of bore 100 about a 360-degree radius and mechanically affixes captive float nut 1 into the interior surface of bore 100 in the material.

Subsequent to tine elements 45 being expanded, embedded and affixed within bore 100, installation tool 200 is reversed out of threaded aperture 25 and used in the next installation, providing a zero-added footprint captive float nut.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. A captive float nut comprised of:
a nut body having an aperture defined there-through, and,
an anchor element comprising at least one finger element having a tine element defined on an outwardly depending terminal portion of the finger element.

2. A captive float nut comprised of:
a nut body comprising a base element, a shaft element, a flange element and having an aperture defined there-through,
an anchor element comprising a retaining element, at least one finger element having a tine element defined on an outwardly depending terminal portion of the finger element, and,
wherein the anchor element is moveably affixed to the nut body to permit a predetermined range of motion of the nut body in six degrees of freedom with respect to the anchor element.

3. A captive float nut comprising:
a nut body comprising a base element, a shaft element, a flange element and having an internally threaded bore defined there-through,
an anchor element comprising a retaining element, at least one finger element having a tine element defined on an outwardly depending terminal portion of the finger element, and,
wherein the anchor element is moveably affixed to the nut body to permit a predetermined range of motion of the nut body in six degrees of freedom with respect to the anchor element.
